(19) United States
(12) Patent Application Publication
(10) Pub. No.: US 2012/0037089 A1
(43) Pub. Date: Feb. 16, 2012

(54) APPARATUS FOR PROMOTING THE HEALING OF A HOOF OR LEG INJURY OR DISEASE OF AN ANIMAL, PARTICULARLY A HORSE

(76) Inventor: Michael Puhl, Losheim am See (DE)

(21) Appl. No.: 13/138,888

(22) PCT Filed: Apr. 16, 2010
(86) PCT No.: PCT/DE2010/000451

§ 371 Date: Oct. 18, 2011

(30) Foreign Application Priority Data
Apr. 23, 2009 (DE) 20 2009 005 945.6

(51) Int. Cl. A61D 3/00; A01K 15/04

(52) U.S. Cl. 119/725; 119/728

(57) ABSTRACT

Apparatus for promoting the healing of a hoof or leg injury or disease of an animal, particularly a horse, comprises a strap to be placed around the trunk of the animal and a mounting by means which the strap can be pulled upward. The strap is mounted by way of a balancer to a fixture that can be moved two-dimensionally in a horizontal plane. The fixture comprises a carriage disposed on a slide rail, which is arranged and displaceable on two slide rails oriented at a right angle thereto, wherein the slide rails are arranged in a cuboid or cube-shaped frame. The strap is fastened with the two ends thereof to mutually parallel sides of a two-dimensional cross bar, which at or close to the center thereof is connected to the balance, and is composed of a number of individually tensionable supporting straps having a common, preferably breathable, cushioning pad.

The invention relates to an apparatus for promoting the healing of a hoof or leg injury or of a hoof or leg disease of an animal, particularly of a horse, said apparatus having a girth to be placed about the body of the animal and a suspension system by means of which the girth can be pulled upward.

It is known to use such an apparatus to suspend horses completely or just to raise their forelegs off the ground in order to treat one foreleg or in order to keep weight off it for a period of time, e.g. after an operation.

The object underlying the invention is to open up a further possibility for exercising influence.

As claimed in the invention, this purpose is served by an apparatus of the aforementioned type where the girth is suspended from a support, which is freely movable in a two-dimensional manner in a horizontal plane, by means of a balancer.

Using the apparatus as claimed in the invention, an animal is able to have and should only have part of its weight supported, for example by 150, 200 or 250 kp, but for a lengthy duration.

The weight support is set at the balancer and is held by the balancer, regardless of the length of extension of a cable of the balancer. In this way, the animal is able to recline, even in an upright position, by bending in its legs. Having its weight supported allows it to maintain this position for a comparatively long period. Over and above this, having its weight supported facilitates standing upright and consequently reduces the risk of putting too much weight on the injured or diseased foreleg or hind leg.

In this case, a horse, for example, has the identical possibilities to move forwards and backwards, to both sides and to turn around which it also has in its box under normal conditions; it pulls the movable support along with it. It is simply not able to lie on its side.

In an expedient manner, the balancer is adjustable to a tensile force which lies between 50 and 250 kp. Supporting the weight by less than 50 kp is hardly worthwhile at any rate in the case of a horse—as a rule a horse weighs 500-600 kp. The horse is not able to tolerate more than 250 kp very well over longer periods.

The cable extended from the balancer can be lockable by removing the upwardly directed tensile force, in particular at a maximum, preferably adjustable length of stretch. By limiting the length of stretch, the animal can be prevented from lying down if this is necessary, for example, for its treatment.

In addition, it is conceivable to support the weight of the animal by several straps, which in each case are suspended by means of a balancer. If one balancer is provided in each case for the forequarters and for the hind quarters or for each leg of the horse, the respective weight supported is able to be adjusted in a more precise manner.

The aforesaid support has a carriage, for example, which is arranged on a running rail which is arranged and can be driven on two running rails which are oriented at a right angle to said first running rail.

As claimed in a further advantageous development of the invention, the running rails are arranged in a cuboid shaped or cube-shaped frame, wherein the last-mentioned two running rails are preferably fixed parts of the frame.

Depending on the conditions, e.g. in a veterinary/equine hospital, it is also possible, however, for the running rails to be attached to the ceiling of a stall, where applicable by means of spacers.

In an expedient manner, the girth is fastened by way of its two ends to sides of a downwardly curved or V-shaped crossbeam which are parallel to each other, said crossbeam being connected at or near to its centre to the balancer.

This means that the girth does not restrict the animal when its two ends are brought together.

The girth preferably consists of a number of individually tensile support straps with a common, preferably breathable, cushioning underlayer.

In an expedient manner, there are provided a holding strap which can be guided from the front about the animal and/or a holding strap which can be guided over the hindquarters of the animal, said holding straps being connected to the girth and preferably having adjustable lengths.

In one development of the invention, the girth includes support material which partially wraps around at least one leg of the animal, is to be arranged on the body of the animal and adapts to the shape of the body. In particular, when the weight of the forequarters and of the hindquarters of the animal or of the legs individually is supported by means of a balancer in each case, such a support material is suitable to transmit the weight-supporting forces onto the body of the animal.

In a further development of the invention, a power connection that is movable with the support is provided. Medical equipment for treating the animal, for example a cooling unit, an infusion machine or an infrared lamp can be supplied from above with power. It is not necessary to lay lines on the floor. In an expedient manner, the support and/or the crossbeam are set up as means for securing the medical equipment. The equipment no longer has to be set up close to the animal and does not disturb its freedom of movement.

The drawings reproduce exemplary embodiments of the invention, in which:

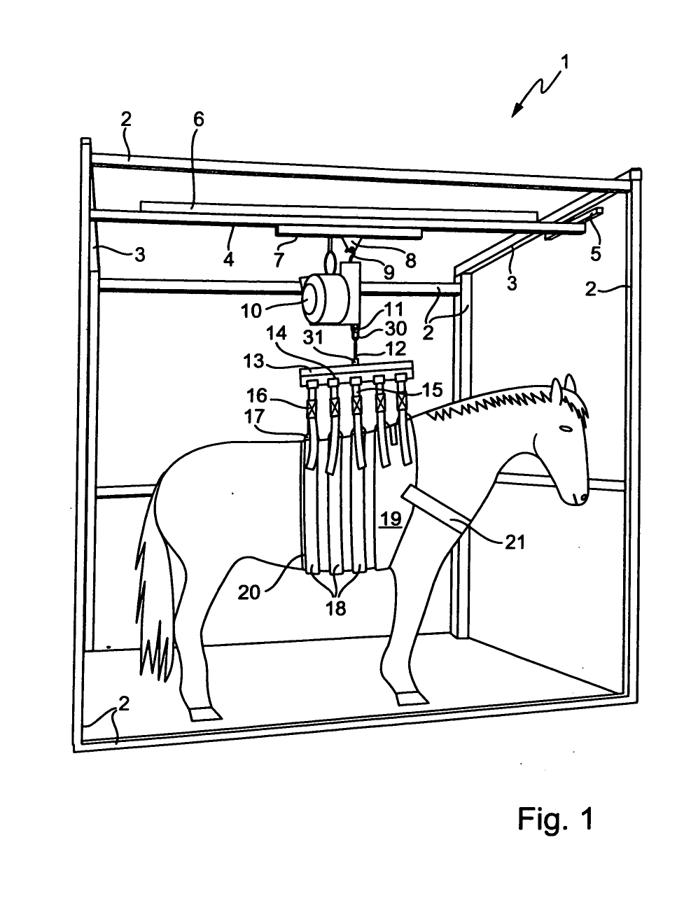

FIGS. 1 to 3 show a perspective view of apparatuses to support the weight of a horse and

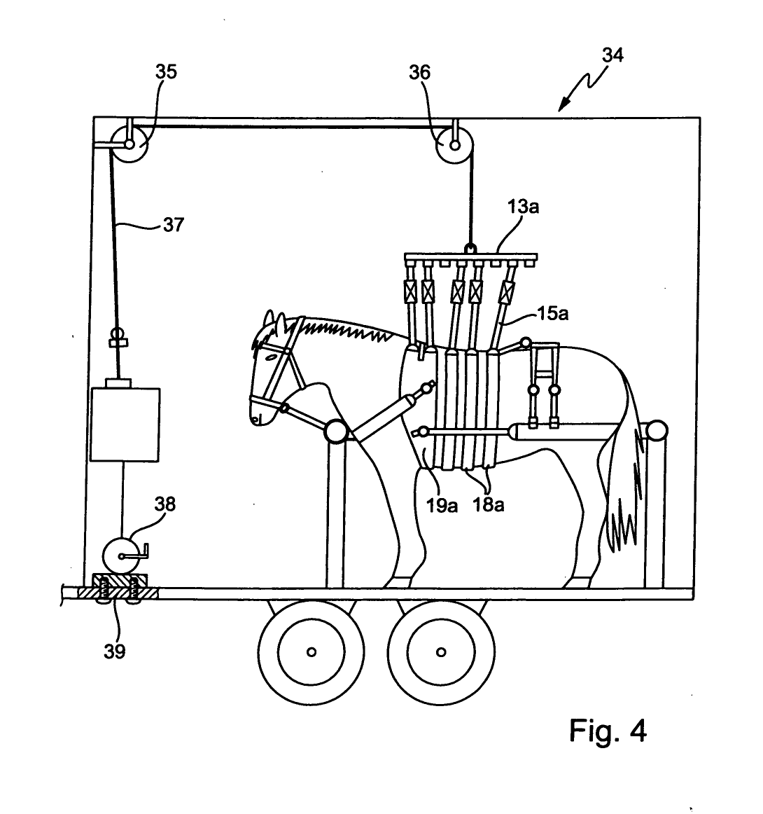

FIG. 4 shows a schematic representation of an apparatus arranged in a trailer.

A substantially cube-shaped frame 1, with the dimensions of, for instance, 3×3×3 m, consists of rectangular tubing 2 with the exception of three C-profiles 3 and 4.

The two C-profiles 3 are fixedly incorporated into the welded assemblage of the frame 1. They form two horizontal, parallel running rails for two carriages 5, to which the C-profile 4 is attached. The C-profile 4, which is provided on its back with reinforcement 6, forms a running rail for a carriage 7.

The carriage 7 is consequently movable in a two-dimensional manner in a horizontal plane. It has a support 8 for suspending a hook.

A balancer 10 is suspended from a support 8 by way of a hook 9. The balancer could also be screw-connected in a direct manner to the carriage 7, thus dispensing with the parts 8 and 9.

A cable 11 of the balancer 10 is only extended a little in this case. A stopper 30 forms the start of the extendable cable, to which is connected a cable loop 12.

The cable loop 12 is connected to a crossbeam 13 by means of a ball bearing swivel 31.

The crossbeam 13 consists of a frame, for instance of the width of the horse, the connecting means 12, 31 cooperating with the centre thereof. Several eyes 14 are attached in each case on both longitudinal sides of frame and tension belts 15 are placed through said eyes. Support belts 18 and 19, which are placed about the body of the horse, are connected with the aid of connecting members 17 to the tensioning belts 15, which can be tensioned by means of turnbuckles 16. A cushioning underlayer 20, for instance 5 cm thick, is inserted under the straps 18 and 19. Said underlayer is produced from fibers in the manner of a mattress in order to be breathable.

A belt 21 placed at the front about the body of the horse holds the entire girth arrangement connected to the forelegs of the horse; this means that it cannot slip rearward.

The sides of the frame are closed by timber panels 23, for instance up to half the height of the horse. The timber panel 23 is removed on the inspection side.

The balancer 10 has been adjusted to a desired tensile force. The crossbeam 13 has been arranged at a suitable height by means of the tensioning belts 15, which are tightened one after the other, with the cable 11 being removed from the balancer 10 in a corresponding manner.

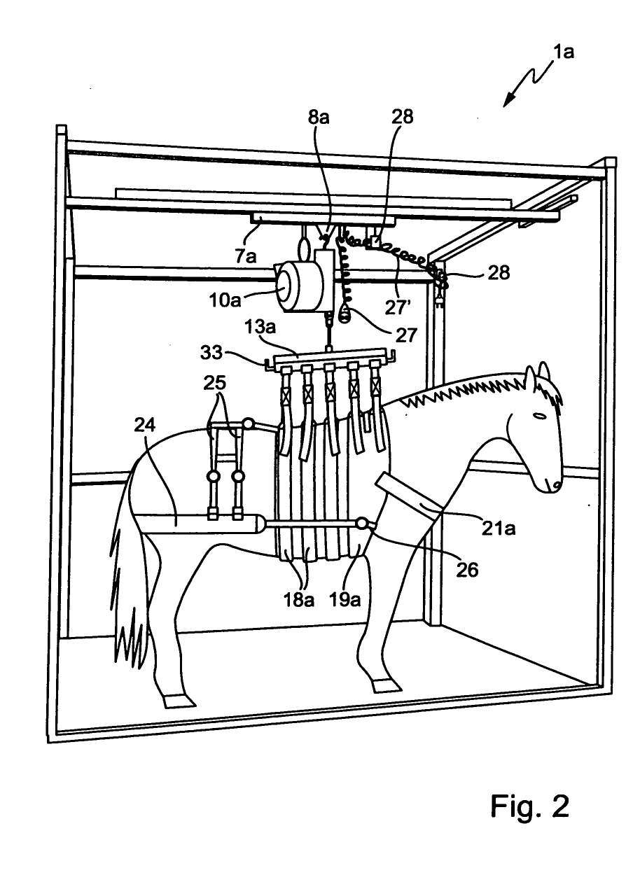

Reference is now made to FIGS. 2 to 4 where identical or equally acting parts are designated with the same reference number as in FIG. 1 and a letter is added to the reference number concerned.

As produced from FIG. 2, a holding strap 24 can be provided placed about the hindquarters of the horse, said holding strap being connected to a support strap 19a by means of a tensioning strap 26. Further straps 25, which prevent the holding strap 24 slipping down, are provided on the hindquarters of the horse. The holding strap 24 prevents the straps 18a, 19a slipping forward.

The lengths of both a strap 21a and of the holding straps 24, 25 are adjustable so they can be adapted to the size of the horse.

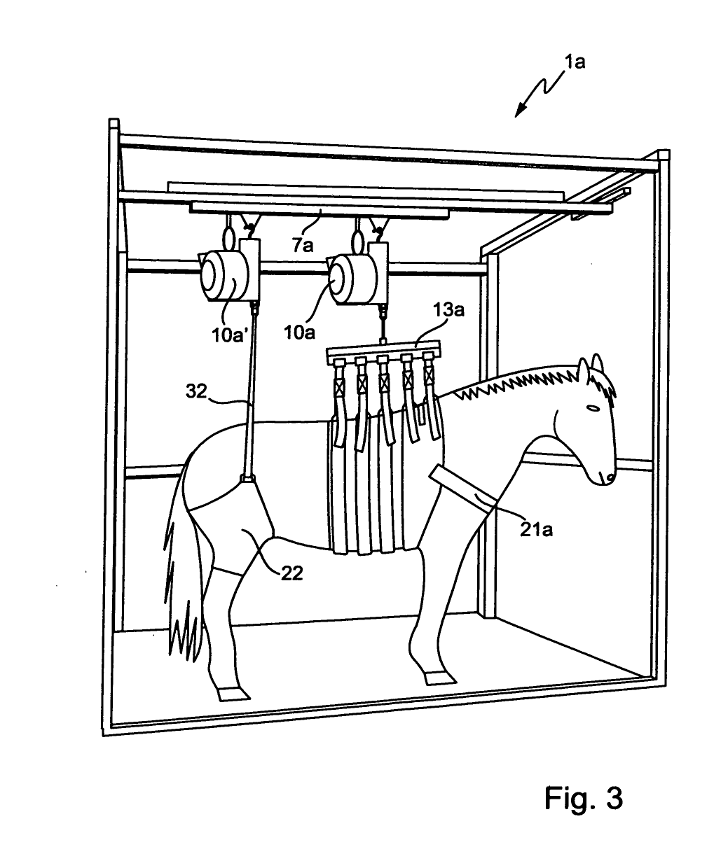

As is shown in the embodiment in FIG. 3, the weight of the horse can also be supported by two balancers. Apart from a balancer 10a, by means of which support straps fastened to the forequarters of the horse take the weight of the horse, a further balancer 10a is fastened to a carriage 7a above the hindquarters of the horse and a support cloth 22 is fastened to said further balancer by means of a support belt 32. The support cloth 22 fits closely to the hind legs and a part of the body similar to a pair of pants. In this case it is provided in such a manner that no force bears against the soft parts of the horse when the support cloth 22 takes the load. The support cloth 22 is formed from a material that adapts to the shape of the body in order to obtain uniform distribution of the close-fitting force and to avoid pressure points.

In an embodiment not shown, a balancer is provided above the hindquarters of the horse in each case for each leg. Each balancer is connected in each case to one side of the support cloth. In this way, it is possible to adjust the weight support for each leg. In addition, it is also conceivable to provide a balancer and a corresponding support cloth in each case for each of the four legs.

A power connection 27 that can be moved with the support 8 is shown in FIG. 2. To this end, a spiral-shaped power cable 27 is fastened to the carriage 7 and to a corner post of the frame 1a by means of holders 28. Medical equipment fastened to a crossbeam 13a can be supplied with power at the power connection 27. Holders 33, which are only shown here in a schematic manner, are provided on the crossbeam 13a for securing the medical equipment.

The apparatus as claimed in the invention can also be provided in a horse walker, in which the animal is walked in a motor-driven manner along a certain distance. The horse is made to move while the intended weight is supported. In an advantageous manner, this means that the healing process can be accelerated and the risk of illnesses occurring on account of the animal not being able to move adequately can be reduced. In addition, it is conceivable to arrange the apparatus as claimed in the invention above a moving walkway for animals.

In the exemplary embodiment shown in FIG. 4, an apparatus as claimed in the invention is provided in a transport trailer 34 for horses. Straps 18a, 19a supporting a horse are connected to a cable 37, which is guided by means of guide pulleys 35, 36, by means of tensioning belts 15a and a crossbeam 13a. The cable 37 is connected to a cable 11a of a balancer 10a which is fastened by means of a winch 38 to a fastening means 39 on the floor of the transport trailer 34. The height of the crossbeam 13a can be adjusted by means of the winch 38. A maximum length of stretch can be set at the balancer 10a such that, for example, the horse can be prevented from lying down in the transport trailer 34.

1. An apparatus for promoting the healing of a hoof or leg injury or of a hoof or leg disease of an animal, particularly of a horse, said apparatus having a girth to be placed about the body of the animal and a suspension system by means of which the girth can be pulled upwards, wherein the girth is suspended from a support, which is freely movable in a two-dimensional manner in a horizontal plane, by means of a balancer.

2. The apparatus as claimed in claim 1, wherein the support has a carriage which is arranged on a running rail which is arranged and can be driven on two running rails which are oriented at a right angle to said first running rail.

3. The apparatus as claimed in claim 2, wherein the running rails are arranged in a cuboid-shaped or cube-shaped frame.

4. The apparatus as claimed in claim 1, wherein the girth is fastened by way of its two ends to sides of a two-dimensional crossbeam (which are parallel to each other, said crossbeam being connected at or near to its centre to the balancer.

5. The apparatus as claimed in claim 1, wherein the girth comprises a number of individually tensile support straps with a common, preferably breathable, cushioning underlayer.

6. The apparatus as claimed in claim 1, wherein there are provided a holding strap which can be guided from the front about the animal and/or a holding strap which can be guided over the hindquarters of the animal, said holding straps being connected to the girth.

7. The apparatus as claimed in claim 1, wherein the girth includes support material which partially wraps around at least one leg of the animal, is to be arranged on the body of the animal and adapts to the shape of the body.

8. The apparatus as claimed in claim 1, wherein the balancer is adjustable to a tensile force which lies between 50 and 250 kp and preferably a maximum length of stretch of a cable of the balancer is provided at which the balancer locks.

9. The apparatus as claimed in claim 1, wherein a plurality of balancers are provided.

10. The apparatus as claimed in claim 1, wherein a power connection that is movable with the support is provided and preferably the support or the crossbeam is or are set up as means for fastening equipment for treating the animal.
